(19) United States
(12) Patent Application Publication
(10) Pub. No.: US 2012/0045969 A1
(43) Pub. Date: Feb. 23, 2012

(54) POLISHING AMORPHOUS/CRYSTALLINE GLASS

(75) Inventors: Ian Beresford, Milpitas, CA (US); Robert Lloyd Babcock, Milpitas, CA (US)

(73) Assignee: SEAGATE TECHNOLOGY LLC, Scotts Valley, CA (US)

(21) Appl. No.: 13/210,315

(22) Filed: Aug. 15, 2011

Related U.S. Application Data
(63) Continuation of application No. 12/208,100, filed on Sep. 10, 2008, now abandoned.

(51) Int. Cl. B24B 1/00; C09K 3/14; B24B 41/06

(52) U.S. Cl. 451/36; 451/364; 51/308

(57) ABSTRACT

An apparatus and associated method for polishing a workpiece with a polishing slurry having ceria particulates and silica particulates.

### RELATED APPLICATION

This is a continuation application of U.S. patent application Ser. No. 12/208,100 filed Sep. 10, 2008.

### BACKGROUND OF THE INVENTION

Magnetic recording media are widely used in various applications, particularly in the computer industry. A portion of a recording medium 1 utilized in disk form in computer-related applications is schematically depicted in FIG. 1 and comprises a non-magnetic substrate 10, of metal, e.g., an aluminum magnesium (Al—Mg) alloy, having sequentially deposited thereon a plating layer 11, such as of amorphous nickel-phosphorous (NiP), a polycrystalline underlayer 12, of chromium (Cr) or a Cr-based alloy, a magnetic layer 13, e.g., of a cobalt (Co)-based alloy, a protective overcoat layer 14, containing carbon (C), e.g. diamond-like carbon (“DLC”), and a lubricant topcoat layer 15, of a perfluoropolyether compound applied by dipping, spraying, etc.

In operation of medium 1, the magnetic layer 13 can be locally magnetized by a write transducer or write head, to record and store data/information. The write transducer creates a highly concentrated magnetic field which alternates direction based on the bits of information being stored. When the local magnetic field produced by the write transducer is greater than the coercivity of the recording medium layer 13, then the grains of the polycrystalline medium at that location are magnetized. The grains retain their magnetization after the magnetic field produced by the write transducer is removed. The direction of the magnetization matches the direction of the applied magnetic field. The pattern of magnetization of the recording medium can subsequently produce an electrical response in a read transducer, allowing the stored medium to be read.

Thin film magnetic recording media are preferably employed in disk form for use with disk drives for storing large amounts of data in magnetizable form. Preferably, one or more disks are rotated on a central axis in combination with data transducer heads. In operation, a typical contact start/stop (“CSS”) method commences when the head begins to slide against the surface of the disk as the disk begins to rotate. Upon reaching a predetermined high rotational speed, the head floats in air at a predetermined distance from the surface of the disk due to dynamic pressure effects caused by the air flow generated between the sliding surface of the head and the disk. During reading and recording operations, the transducer head is maintained at a controlled distance from the recording surface, supported on a bearing of air as the disk rotates, such that the head can be freely moved in both the circumferential and radial directions, allowing data to be recorded on and retrieved from the disk at a desired position. Upon terminating operation of the disk drive, the rotational speed of the disk decreases and the head again begins to slide against the surface of the disk and eventually stops in contact with and pressing against the disk. Thus, the transducer head contacts the recording surface whenever the disk is stationary, accelerated from the static position, and during deceleration just prior to completely stopping. Each time the head and disk assembly is driven, the sliding surface of the head repeats the cyclic sequence consisting of stopping, sliding against the surface of the disk, floating in air, sliding against the surface of the disk, and stopping.

It is considered desirable during reading and recording operations, and for obtainment of high areal recording densities, to maintain the transducer head as close to the associated recording surface as is possible, i.e., to minimize the “flying height” of the head. Thus, a smooth recording surface is preferred, as well as a smooth opposing surface of the associated transducer head, thereby permitting the head and the disk surface to be positioned in close proximity, with an attendant increase in predictability and consistent behavior of the air bearing supporting the head during motion.

Meanwhile, the continuing trend toward manufacture of very high areal density magnetic recording media at a reduced cost provides impetus for the development of lower cost materials, e.g., polymers, glasses, ceramics, and glass-ceramics composites as replacements for the Al alloy-based substrates for magnetic disk media. However, poor mechanical and tribological performance, track mis-registration (“TMR”), and poor flyability have been particularly problematic in the case of polymer-based substrates fabricated as to essentially copy or mimic hard disk design features and criteria. On the other hand, glass, ceramic, or glass-ceramic materials are attractive candidates for use as substrates for very high areal density disk recording media because of the requirements for high performance of the anisotropic thin film media and high modulus of the substrate. However, the extreme difficulties encountered with grinding and lapping of glass, ceramic, and glass-ceramic composite materials have limited their use to only higher cost applications, such as mobile disk drives for “notebook”-type computers.

Although the bulk properties of glass-ceramics are ideal for substrate disks, historically, there has been no successful method for polishing the surface of the disks to meet the requirements for magnetic media storage with respect to waviness and roughness. The two phases of the glass ceramics have difference properties and using the polishing slurries of the prior art, the two phases polish at different rates. Slurries that are successful at polishing the harder crystal portions, include large particulates to grind down the crystals. However, these large particulates simultaneously cause scratches and crevices in the softer amorphous portion of the substrate. On the other hand, prior art slurries that are successful at polishing the amorphous glass are not abrasive enough to polish the crystal portions. The use of such slurries results in crystal structures protruding from the amorphous matrix at the surface of the substrate. Thus polishing methods using either of the prior art slurries do not provide substrate surfaces with adequate capability for current disk drive technology and requirements, particularly with respect to substrate micro-roughness, waviness, and uniformity.

There exists a clear need for improved means and methodology for providing high modulus glass ceramic substrates for magnetic data/information storage and retrieval media, e.g., disk-shaped substrates, with at least one surface thereof having requisite topography, i.e., low waviness over the entire surface together with lower average roughness, for enabling operation of the media with read/write transducers/heads operating at very low flying heights.

### SUMMARY OF THE INVENTION

In some embodiments of the present invention a polishing slurry is provided for polishing a workpiece, the polishing slurry having ceria particulates and silica particulates.

In some embodiments of the present invention a method is provided for: obtaining a polishing slurry having constituent ceria particulates and constituent silica particulates; and polishing a surface of a workpiece with the polishing slurry.

In some embodiments of the present invention a workpiece polishing apparatus is provided having a workpiece support structure and a polishing structure operably moving a polishing pad in relation to the workpiece support structure, and further having means for polishing the workpiece so that different constituent materials of the workpiece, each having a different respective hardness, are operably polished substantially equally.

### BRIEF DESCRIPTION OF THE DRAWINGS

The following detailed description of the embodiments of the present invention can best be understood when read in conjunction with the following drawings, in which the features are not necessarily drawn to scale but rather are drawn as to best illustrate the pertinent features, wherein:

FIG. 1 illustrates, in schematic, simplified cross-sectional view, a portion of a thin film magnetic data/information storage and retrieval medium;

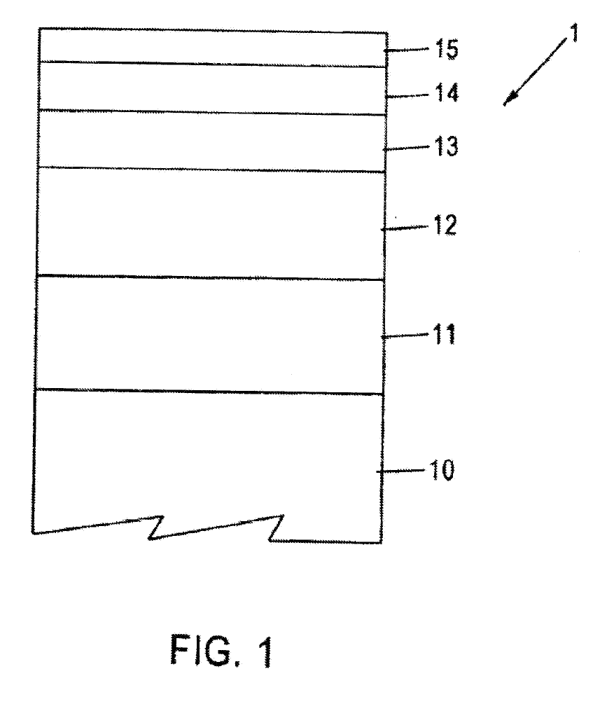

FIG. 2 illustrates, in schematic, simplified view, a process flowchart for polishing glass, ceramic, or glass-ceramic substrates according to the inventive methodology:

FIG. 3 illustrates, in schematic, simplified cross-sectional view, a system diagram for each of the processing systems PS 1 and PS 2 of FIG. 2;

FIG. 4 shows roughness analysis of a substrate formed using the present invention; and

FIG. 5 shows roughness analysis of another substrate formed using the present invention.

### DETAILED DESCRIPTION OF THE PREFERRED EMBODIMENTS

The present invention relates to improved methods and apparatus for processing surfaces of glass substrates to provide low roughness and low, uniform waviness over the substrate surface. The invention has particular utility in surface preparation (i.e., polishing) of disk-shaped glass ceramic substrates for use in the manufacture of magnetic data/information storage and retrieval media, e.g., hard disks.

As employed herein, the term “glass-ceramics” is taken to include those materials which are melted and fabricated as true glasses, and then converted to a partly crystalline state, such materials being mechanically stronger, tougher, and harder than the parent glass, as well as non-porous and finer-grained than polycrystalline materials. Glass-ceramic materials provide an advantage over amorphous glass for the manufacture of substrates of magnetic storage disks because the production of glass ceramic substrates is less costly. Substrates formed from amorphous glass require a hardening process to meet manufacturing constraints for substrate disks. This additional process is not necessary for glass ceramic substrates because they inherently meet this constraint. Likewise, glass ceramic materials are also advantageous over a single crystal material because the raw material properties and costs of single crystal materials are not suitable for glass substrates.

In the present invention, the term “polished substantially equally” refers to surface polishes that do not differ by more than about 25%. For example, the amorphous glass portion and the crystalline portion of the at least one surface are polished substantially equally if the surface polish of an amorphous glass having the structure and composition of the amorphous glass portion and the surface polish of a crystalline material having the structure and composition of the crystalline portion do not differ by more than about 25% when the methods for polishing both the amorphous glass and the crystalline material are the same and the surface polishes of the amorphous glass and crystalline material before polishing are nearly the same.

The present invention addresses and solves problems and difficulties attendant upon the surface preparation of very hard, high modulus glass-ceramics for use as substrate materials in the manufacture of very high areal density magnetic recording media, thin film, high areal density magnetic and/or magneto-optical (MO) recording media, while maintaining full capability with substantially all aspects of automated manufacturing technology for the fabrication of thin-film magnetic media. Further, the methodology and means afforded by the present invention enjoy diverse utility in the manufacture of various other devices and media requiring formation of low waviness, low average surface roughness surfaces on high hardness materials.

An advantage of the present invention is an improved method of polishing at least one surface of a glass-ceramic substrate.

Another advantage of the present invention is an improved method of polishing at least one surface of a glass, ceramic, or glass-ceramic substrate to minimize the waviness, the variation in waviness, and the average surface roughness of the at least one surface, whereby the substrate is usable as a substrate for a magnetic or magneto-optical (MO) data/information storage retrieval medium.

Yet another advantage of the present invention is an improved slurry formulation for polishing at least one surface of a glass, ceramic, or glass-ceramic substrate.

A further advantage of the present invention is an improved slurry formulation for polishing at least one surface of a glass, ceramic, or glass-ceramic substrate to minimize the waviness, the variation in waviness, and the average surface roughness of said at least one surface, whereby the substrate is suitable as a substrate for a magnetic or magneto-optical (MO) data/information storage retrieval medium.

Additional advantages and other aspects and features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims.

According to one embodiment of the present invention, the foregoing and other advantages are obtained in part by a method of polishing at least one surface of a glass-ceramic substrate to minimize the waviness, the variation in waviness, and the average surface roughness of the at least one surface, whereby the substrate is usable as a substrate for a magnetic or magneto-optical (MO) data/information storage retrieval medium, the method comprising a step of polishing the at least one substrate surface using a polishing slurry including both SiO₂ and CeO₂ particles with a formulation that is operable to polish the amorphous glass portion and the crystalline portions of the glass ceramic substrate at substantially equal rates.

According to another embodiment of the present invention, a method is provided of polishing at least one surface of a glass-ceramic substrate to minimize the waviness, the variation in waviness, and the average surface roughness of the at least one surface, whereby the substrate is usable as a substrate for a magnetic or magneto-optical (MO) data/information storage retrieval medium, the method compromising a step of polishing the at least one substrate surface using a polishing slurry including at least 50% ceria particulates as well as silica particulates suspended in a solution, whereby the amorphous glass portion and the crystalline portions of the glass ceramic substrate are polished substantially equally.

According to yet another embodiment of the present invention, a method is provided of polishing at least one surface of a glass-ceramic substrate to minimize the waviness, the variation in waviness, and the average surface roughness of the at least one surface, whereby the substrate is usable as a substrate for a magnetic or magneto-optical (MO) data/information storage retrieval medium, the method comprising a step of polishing the at least one substrate surface using a polishing slurry including both ceria particulates, having a size between 30 and 50 nm, as well as silica particulates suspended in a solution, whereby the amorphous glass portion and the crystalline portions of the glass ceramic substrate are polished substantially equally.

The present invention is based upon the discovery by the present inventors that the surfaces of the aforementioned substrate materials can be successfully polished to yield substrates suitable for use in such applications, i.e., with minimum waviness, minimum waviness variation over the substrate surface, and very low average surface roughness (Ra).

The present invention is based upon the discovery by the present inventors that small ceria (CeO₂) particulates combined with silica (SiO₂) particulates in a polishing slurry may be used for facilitating polishing of the aforementioned hard-surfaced, high modulus glass ceramics to yield polished surfaces consistent with requirements for their use in the manufacture of high areal density recording media.

This combination of particulates in a polishing slurry when used to polish the aforementioned substrates provides a polishing system and methodology which differs from prior systems and methodologies in addressing and meeting the requirements for current disk drive technology, including, inter alia, requirements for micro-roughness, waviness, and uniformity of polished surfaces of glass-ceramic substrate materials for manufacture of high areal density thin film recording media. Specifically, the inventive means and methodology differs from prior polishing systems and methodologies in allowing the use of a single polishing slurry to polish the amorphous glass and crystalline portions of the glass ceramic substrates at a substantially equal removal rates. Accordingly, the inventive means and methodology affords obtainment of lower surface waviness, consistently low surface waviness over the entire surface, and lower average roughness (Ra). The method of the invention has been demonstrated to yield substrate surfaces with roughness Ra below 2.0 Å, and particular embodiments have yielded substrate surfaces with roughness below 1.3 Å.

In one embodiment of the invention, the Ceria particulates of the inventive polishing slurry are nano-sized particles. For example, the Ceria particulates may be in the rage of 30-50 nanometers. The small sized ceria particles act to remove material from the crystalline structures within the glass ceramic substrate at a similar rate that the amorphous glass portion of the substrate is removed. As a result, the polished surface of the glass ceramic substrate has a low enough roughness and waviness to meet with the stringent requirements for making high areal density recording media. With the size of the Ceria particulate at this magnitude, it may be of a similar size to the Silica particulates used in the slurry. For example, the size range of the Ceria particulate may overlap with the size range of the Silica particulates. In one embodiment, the Silica particulates have a size range of 15 nm-45 nm, which overlaps with the aforementioned range of the Ceria particulate size of 30-50 nm.

The formulation of the polishing slurry may be varied depending on the makeup of the glass ceramic substrate. For example, a first formulation of slurry may be effective for polishing a first glass ceramic substrate, while a second formulation of slurry may effective for polishing a second glass ceramic substrate. If the first glass ceramic substrate contains a higher ratio of crystalline portions than the second, the first slurry may include a higher concentration of Ceria particulates. Thus, part of the method of polishing the glass substrates includes varying the concentrations of Ceria and Silica particulates based on the ratio of the amorphous glass portion to the crystalline portion. It is also advantageous to vary the ratio of Ceria particulates to Silica particulates based on the makeup of the glass ceramic substrates. In a preferred embodiment of the invention, the slurry includes at least 10% Ceria particulates and at least 20% Silica particulates. The remaining constituents of the slurry include lubricants to reduce friction and particle breakdown, suspension agents to maintain the particles in solution, pH buffers to maintain a desired pH range, optional detergents to aid in cleaning & rinsing of the substrates post polishing, and water. Polishing with the polishing slurry of the invention has been demonstrated as particularly successful with glass ceramic substrates wherein the crystalline portion makes up at least 25% of the material.

In a particularly advantageous embodiment of the invention, the polishing slurry may have a pH that is low in comparison to those of the prior art. The high pH of prior art slurries is considered advantageous in that it softens the amorphous glass of the substrate making it more susceptible to removal by the particulates. However, in order to balance the removal rate of the amorphous glass portion and the crystalline portion of the glass ceramic, the present invention uses a slurry with a low pH. For example, the pH may be in a range of 3.7-4.8, such that the amorphous glass portion of the substrate is hardened. As a result, the removal rate of the amorphous glass portion is retarded such that it is closer to the range of that of the crystalline portion.

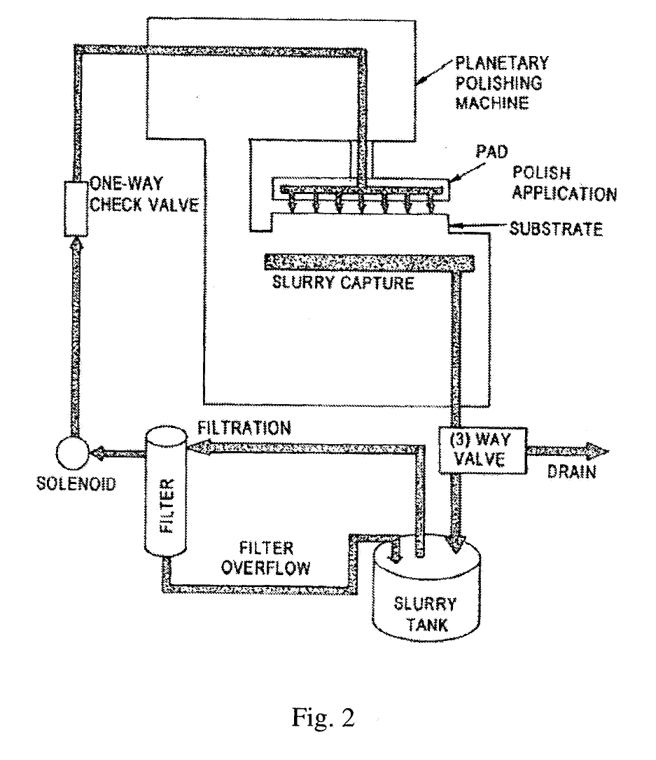

Adverting to FIG. 2, illustrated therein, in schematic, simplified cross-sectional view, is a diagram of a processing systems for polishing the substrates. As shown therein, abrasive slurry of the present invention contained in a slurry tank or reservoir is supplied, via a conduit, to a filter for removing therefrom abrasive particles, polishing debris, etc., of sizes greater than a pre-selected maximum size determined by the particular filter element, and supplied by a further conduit, solenoid valve, and one-way check valve to a planetary polishing machine, e.g., a Speedfam machine manufactured by Speedfam-IPEC, now Novellus Systems, Inc., San Jose, Calif., wherein the slurry is supplied to a porous or woven polishing pad via a distribution manifold for application to the surface of a substrate being polished. Captured slurry from the polishing process is supplies, via a conduit equipped with a 3-way valve, back to the slurry tank or reservoir for re-use, or to a drain. In addition, the filter is provided with a conduit for returning overflow slurry to the slurry tank or reservoir.

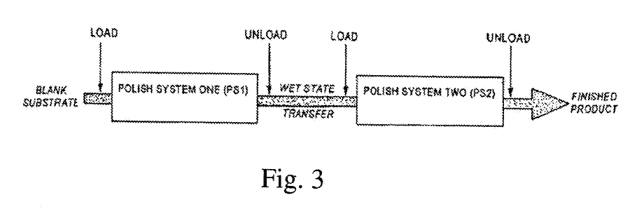

In one embodiment of the invention, a process for polishing the glass ceramic substrates includes two polishing steps, wherein the polishing slurry set forth above is used in a final polishing system (PS 2) after a preliminary polishing system (PS1). Referring to FIG. 3, shown therein in schematic, simplified view, is a process flowchart for polishing of the glass-ceramic substrates according to this embodiment, wherein substantially similar first and second planetary polishing systems (such as manufactured by Speedfam-IPEC, now Novellus Systems, Inc., San Jose, Calif.) are serially arranged for performing a first, preliminary polishing and a second, final polishing of glass-ceramic substrate materials. As illustrated, a blank substrate is loaded into the left (inlet) side of a first polishing system (PS 1) equipped with a treated (i.e., hardened) polyurethane or woven polishing pad and supplied with a CeO₂-based abrasive polishing slurry and a 10 μm (nominal) polypropylene filter located in a slurry recirculation loop. Preliminarily polished substrates exiting the first polishing system are unloaded at the right (outlet) side of the first polishing system and transferred in a wet state to be loaded into the left (inlet) side of a second polishing system (PS 2) similarly equipped with a treated (i.e., hardened) polyurethane or woven polishing pad and supplied with the abrasive polishing slurry described above and a 5 μm (nominal) polypropylene filter located in a slurry recirculation loop. Finally polished substrates exiting the second polishing system are unloaded at the right (outlet) side of the second polishing system. Each of the first polishing system inlet, first polishing system outlet, and second polishing system outlet is provided with inspection and/or process control/audit means and each of the first and second polishing systems is provided with means for independently setting and controlling a number of polishing process parameters (described in more detail below).

By way of illustration, but not limitation, according to an embodiment of the invention especially useful in polishing substrate surfaces for use in manufacture of thin film magnetic and/or magneto-optical recording media, up to about 50 μm of glass, ceramic, or glass-ceramic material is removed from the surface of the substrate in the first polishing system (PS1) to form a planar and uniform surface having an average roughness Ra of about 4 Å and a waviness of about 4 Å; and less than about 3 μm of glass, ceramic, or glass-ceramic material is removed from the surface of the substrate in the second polishing system (PS 2) to form a planar and uniform surface having an average roughness Ra of about 2.5 Å and a waviness of about <2 Å over the entire surface. According to this embodiment of the invention, the first, or preliminary, polishing performed in PS 1 utilizes a CeO₂-based first polishing slurry comprising CeO₂ particles having sizes<0.2 μm; and the second, or final, polishing performed in PS 2 utilizes a the aforementioned polishing slurry of the invention.

According to the invention, the use of small particle abrasive slurries with narrow particle size distribution mandates tight filtration of the recirculated slurries. Since slurries with large particle sizes and a broad particle size distribution are detrimental for obtaining the desired enhanced topographies, contamination of the slurries from outside sources of any kind will result in scratching (higher roughness) and higher waviness. Therefore, filtration of the CeO₂-based slurries to remove particles with sizes equal to or greater than about 10 μm and filtration of the slurry of the present invention to remove particles with sizes equal to or greater than about 5 μm is considered preferred for obtaining the desired topography.

In one embodiment, it may be advantageous to prepare the surface of polishing pads used in conjunction with the first and second polishing systems. An illustrative, but no limitative, process for surface preparation of a polishing pad to be used with the method of the invention may be as follows. A virgin high density (i.e., hardness>70 Shore) porous polyurethane or woven polishing pad (e.g., Rodel MH-N15A; Rodel Nitta MH-C14B; or Rodel Suba 1200 (woven), available from Rodel, Inc., Newark, Del., or Rhodes ESM:LP57 or Rhodes ESM:LPM66, available from Universal Photonics, Hicksville, N.Y.) is installed on a platen and subjected to dressing by a diamond dressing ring to remove any surface imperfections such as high and/or low points caused by irregularities in the surface of the underlying platen which project upwardly to the surface of the polishing pad. A solution of an amorphous glass material is then prepared comprising about 10 s vol. % hydrated aluminum silicate and about 2 vol. % lithium silicate (Li₂ Si₂ O₅) in de-ionized H₂O, which solution is then applied to the surface of the polishing pad, as by spraying. The polishing pad is saturated with the solution and allowed to dry. After drying is complete, the polishing pad is run in a planetary polishing machine with a ceramic polishing plate (e.g., YPEX-5, available from MYG Disk Corp., Japan) at a high pressure and RPM with a CeO₂-based abrasive slurry as a lubricant, to which an alkaline (i.e., caustic) reducing agent, e.g., NaOH or KOH, is added to activate the ceramic surface. Heat generated by the friction between the polishing pad and the ceramic plate and the chemical reactions of the curing process produces temperatures above about 120° F. After a specified interval of polishing/curing under high pressure and RPM at elevated temperatures, preferably about 120 min., the polishing pad is allowed to dry for at least about an hour to complete the treatment process wherein material is deposited in the pores and at the surface. A final step, after completion of the curing process, is an optional 60-sec. run of the dressing ring or tool at a low pressure and RPM to remove any excess surface material, after which the treated pad may be used with abrasive slurries for polishing glass ceramic substrates according to the inventive methodology.

### EXAMPLES

To demonstrate the effects of the inventive polishing method on surface roughness, the processes and compositions of two samples that were polished in accordance with the present invention and then evaluated using an atomic force microscope are presented in the following. Both samples were formed of Ohara glass and included 45-55 percent crystalline structure surrounded by a glass matrix. To produce the polished samples both were first polished for 35 minutes using a slurry comprising 29 percent volume of Ceria particulates having a 0.2-0.4 μm size. Subsequently, the surface of the samples were subjected to a final polish for 18 minutes in accordance with the invention. The polishing slurry used in the final polish was comprised of 24% Sg 18R CeO₂, 20% 682 SiO₂, 2% Vector HTN (Triethanolamine lubricant, pH stabilizers & defoamer additives) and a remainder of de-ionized H₂O.

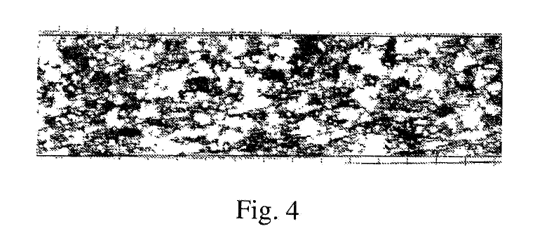

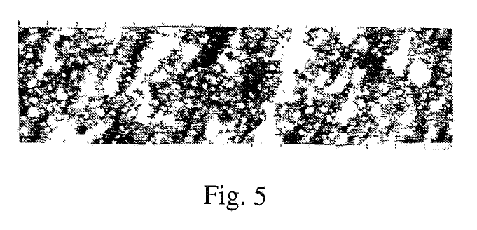

Following the polishing method the samples were examined to determine the surface characteristics of the glass-ceramic substrates. A 5 μm square section of a surface of each substrate was inspected to determine roughness using the atomic force microscope. A small band of each inspected region of the 5 μm section was imaged and is shown in FIGS. 4 and 5. The Figs. Show low surface roughness. The measurements made by the atomic force microscope showed that the first sample shown in FIG. 4 had a mean roughness of 2.92 Å over the measured area, while the second sample shown in FIG. 5 had a mean roughness of 2.91 Å. As can be seen from these results, the polishing method in accordance with the invention produced a substrate surface that meets the stringent requirements of surface roughness for high areal density magnetic and/or magneto-optical (MO) recording media.

To demonstrate the effects of the inventive polishing method on waviness, the processes and compositions of two samples that were polished in accordance with the present invention and then evaluated using a quadrature phase shift interferometer are presented in the following. Both samples were formed of Ohara glass and included 45-55 percent crystalline structure surrounded by a glass matrix. To produce the polished samples both were first polished for 35 minutes using a slurry comprising 29 percent volume of Ceria particulates having a 0.2-0.4 μm size. Subsequently, the surface of the samples were subjected to a final polish for 18 minutes in accordance with the invention. The polishing slurry used in the final polish was comprised of 24% Sg18R CeO₂, 20% 682 SiO₂, 2% Vector HTN (lubricant & additives) and a remainder of de-ionized H₂O.

Following the polishing method each side of all three samples was examined to determine the waviness of the glass-ceramic substrates. Each side (A and B) of the substrates were evaluated for waviness at three different locations. Measurements were taken at an inner diameter (ID), an outer diameter (OD) and a middle diameter (MD) location. The data collected from the six surfaces is shown in Table 1 below. As can be seen from these results, the polishing method in accordance with the invention produced a substrate surface that meets the stringent requirements of surface roughness for high areal density magnetic and/or magneto-optical (MO) recording media.

| | Side | | | | | |
|---|---|---|---|---|---|---|
| Sample | 1A | 1B | 2A | 2B | 3A | 3B |
| ID | 1.40 | 1.41 | 1.30 | 1.36 | 1.31 | 1.34 |
| MD | 1.38 | 1.40 | 1.31 | 1.41 | 1.26 | 1.33 |
| OD | 1.38 | 1.36 | 1.28 | 1.35 | 1.22 | 1.26 |
| Ave. | 1.39 | 1.39 | 1.30 | 1.37 | 1.26 | 1.31 |

As shown, the present invention advantageously provides, as by processing techniques which can be reliably practiced at low cost, improved methodologies and instrumentalities for polishing surfaces of hard-surfaced, high modulus materials glass-ceramic materials, to yield substrates with polished surfaces of sufficiently high quality surface topographies and controlled surface waviness facilitating their sue as substrates for high areal density thin film magnetic and/or MO recording media. In addition, the present invention provides improved means and methodology for high quality surface polishing of a variety of hard-surfaced, high modulus glass-ceramics amenable to polishing with planetary polishing apparatus, which materials may be utilized in the manufacture of a variety of products and devices, such as, for example, semiconductor wafers, optical mirrors and lenses.

In the previous description, numerous specific details are set forth, such as specific materials, structures, reactants, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein. The implementations described above and other implementations are within the scope of the following claims.

What is claimed:

1. A polishing slurry for polishing a workpiece, the polishing slurry comprising:
ceria particulates; and
silica particulates.

2. The polishing slurry of claim 1 wherein the workpiece is a glass ceramic material, the polishing slurry comprising amounts of the ceria particulates and of the silica particulates defined in relation to a composition of the glass ceramic material.

3. The polishing slurry of claim 2 wherein the ceramic glass material has constituent amorphous glass portions and constituent crystalline portions, the polishing slurry comprising amounts of the ceria particulates and of the silica particulates defined in relation to amounts of the amorphous glass portions and of the crystalline portions.

4. The polishing slurry of claim 1 comprising a composition characterized by more than 50% by volume of the ceria particulates.

5. The polishing slurry of claim 1 comprising a composition characterized by sizes of the ceria particulates being within a first range and by sizes of the silica particulates being within a different second range.

6. The polishing slurry of claim 5 characterized by the first range overlapping the second range.

7. The polishing slurry of claim 6 characterized by the first range being between 30 nanometers (nm) and 50 nm and the second range being between 15 nm and 45 nm.

8. The polishing slurry of claim 3 characterized by the crystalline portions making up at least 25% by volume of the glass ceramic material.

9. The polishing slurry of claim 1 characterized by having a pH value in a range of 3.7-4.8.

10. A method comprising:
obtaining a polishing slurry having constituent ceria particulates and constituent silica particulates; and
polishing a surface of a workpiece with the polishing slurry.

11. The method of claim 10 wherein the polishing feature is characterized by the workpiece being a glass ceramic material.

12. The method of claim 11 wherein the obtaining feature is characterized by the polishing slurry having amounts of the ceria particulates and of the silica particulates defined in relation to a composition of the glass ceramic material.

13. The method of claim 12 wherein the polishing feature is characterized by the glass ceramic material having constituent amorphous glass portions and constituent crystalline portions, and the obtaining feature is characterized by the polishing slurry having amounts of the ceria particulates and of the silica particulates defined in relation to amounts of the amorphous glass portions and of the crystalline portions.

14. The method of claim 13 wherein the obtaining feature is characterized by the polishing slurry composition being more than 50% by volume of the ceria particulates.

15. The method of claim 10 wherein the obtaining feature is characterized by sizes of the ceria particulates being within a first range and by sizes of the silica particulates being within a different second range.

16. The method of claim 15 wherein the obtaining feature is characterized by the first range overlapping the second range.

17. The method of claim 13 wherein the polishing feature is characterized by the crystalline portions making up at least 25% by volume of the glass ceramic material.

18. The method of claim 10 wherein the polishing feature is characterized by polishing the at least one surface of the workpiece to have a roughness that is less than 1.4 angstroms.

19. The method of claim 10 wherein the polishing feature is characterized by filtering the polishing slurry with a first filter during a first polishing sequence and then filtering the polishing slurry with a different second filter during a subsequent polishing sequence.

20. A workpiece polishing apparatus, comprising:
a workpiece support structure and a polishing structure operably moving a polishing pad in relation to the workpiece support structure; and
means for polishing the workpiece so that different constituent materials of the workpiece, each having a different respective hardness, are operably polished substantially equally.
